(19) United States
(12) Patent Application Publication
(10) Pub. No.: US 2020/0020024 A1
(43) Pub. Date: Jan. 16, 2020

(54) VIRTUAL PRODUCT INSPECTION SYSTEM USING TRACKABLE THREE-DIMENSIONAL OBJECT

(71) Applicant: Merge Labs, Inc., San Antonio, TX (US)

(72) Inventor: Franklin A. Lyons, San Antonio, TX (US)

(21) Appl. No.: 16/425,581

(22) Filed: May 29, 2019

Related U.S. Application Data
(60) Provisional application No. 62/697,073, filed on Jul. 12, 2018.

(51) Int. Cl. G06Q 30/06; G06T 19/00; G06K 7/14; G06K 9/00; G06F 3/01

(52) U.S. Cl. CPC G06Q 30/0643; G06T 19/006; G06F 3/011; G06K 9/00671; G06K 7/1443

(57) ABSTRACT

A system and method for viewing and inspecting a virtual item for purchase including a handheld trackable three-dimensional physical object for use with an augmented reality application providing a shopper with a life-sized, handheld virtual product allowing the shopper to interact with the virtual product in a natural way by manipulating the physical handheld item.

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by anyone of the patent disclosure as it appears in the Patent and Trademark Office patent files or records, but otherwise reserves all copyright and trade dress rights whatsoever.

### RELATED APPLICATION INFORMATION

This application claims priority to U.S. provisional patent application No. 62/697,073 entitled “Virtual Product Inspection System Using a Trackable Three-Dimensional Object” filed Jul. 12, 2018 which is incorporated herein by reference.

This application is related to related to U.S. nonprovisional patent application Ser. No. 15/860,484 entitled “Three-dimensional Augmented Reality Object User Interface Functions” filed Jan. 2, 2018 and U.S. provisional patent application No. 62/679,146 entitled “Precise placement and animation creation of virtual objects in a user's environment using a trackable physical object” filed Jun. 4, 2018 which are incorporated herein by reference.

### BACKGROUND

### Field

This application relates to augmented reality objects and interactions with those objects along with the physical world.

### Description of Related Art

Augmented reality (AR) is the blending of the real world with virtual elements generated by a computer system. The blending may be in the visual, audio, or tactile realms of perception of the user. AR has proven useful in a wide range of applications, including sports, entertainment, advertising, tourism, shopping and education. As the technology progresses it is expected that it will find an increasing adoption within those fields as well as adoption in a wide range of additional fields.

Virtual reality (VR) is a computer-generated simulation of a three-dimensional image or environment that can be interacted with in a seemingly real or physical way. Usually special electronic equipment, such as a helmet with a screen inside is required for a truly immersive VR experience.

Shopping online using virtual and augmented reality is an emerging market with many companies and industries interested in developing applications to utilize technology in both augmented reality and virtual reality. Current online sales applications exist for using both AR and VR in the online sales market. In an era with many brick and mortar stores closing and companies relying more heavily on online sales, AR/VR applications are going to become even more valuable in the near future.

Already today in the realm of AR, many applications exist for the virtual placement of large items in the shopper's physical environment. For example, if a potential buyer is in need of a new couch, he can use an augmented reality application to find the best fit for his living room. He can use an AR app on his phone to map his living room and its specific measurements. He can then use the app to load a virtual couch with exact known measurements into the image or video of his living room. If he likes the style and color of the couch in the room, and the couch in question will fit in the space available, he can purchase it through the app. The couch can even easily be virtually moved about the room to achieve the best position in the living room. Further, if the couch doesn't meet the needs of the user, it can easily be replaced with another couch for evaluation. When the user is satisfied with a couch, he can then purchase it through the same app. Furniture, televisions, lamps and other large household items can easily be evaluated in the user's environment with applications currently in the market.

Similarly, in the VR world, virtual shopping applications are available that insert a user into a virtual store that looks very similar to a real store, such as a clothing store. These virtual shopping apps provide an expansive overview of clothing offerings of a particular store while giving the shopper the feel of actually being in the store. The VR apps give product information, images of a few different views of a chosen item, and the ability to purchase the item. Some apps even go so far as to provide a virtual assistant to talk the user through the virtual shopping process.

Some online virtual stores also give a three-dimensional image of a product in the display with the ability to interact with the virtual product. For example, a user can see a three-dimensional representation of a dress on a mannequin. The dress can rotate so that the viewer can view the dress with a 360-degree rotation about a near vertical axis. The user can change the color of the dress or the size of the dress and add any available accessories, such as shoes or a purse. The user can then choose items for purchase in the application.

Current virtual online commerce offerings allow the user to view a product usually from the front, back, left and right, or less commonly a three-dimensional representation. Sometimes a user can view an image of a person holding or wearing the product in interest to give him some idea of the scale of the product. Typically, though the size of a product is listed in the description, and the user must then estimate the size.

Online grocery purchase is growing across the USA with all of the major grocers providing at least an online purchase for pick up later, or even a delivery service. Ordering produce particularly can be problematic when using one of the currently available online systems. While a shopper can choose the variety and number of apples he would like to purchase, he has no control over which specific apples are chosen. Often those apples chosen by the personal shopper in the grocery store are not necessarily those that a shopper would choose; they possibly are too small or too big, or have too many bruised spots. What is needed is system and method to evaluate specific pieces of produce for purchase that neither slows down the shopper nor is too complex or time consuming for the shopper.

### DESCRIPTION OF THE DRAWINGS

FIG. 1a is an elevated view of the front, top, and left side view of the three-dimensional object of the preferred embodiment.

FIG. 1b is an elevated view of the rear, bottom, and right side of the three-dimensional object of the preferred embodiment.

FIG. 2 is an illustration of the components of an embodiment for a disclosed system.

FIG. 3 is a flowchart illustrating an example process for an embodiment of of the disclosed AR product evaluation system and method.

FIG. 4a is an illustration of an arbitrary angle of the front right view of a handheld virtual shoe being evaluated in the current system.

FIG. 4b is an illustration of an arbitrary angle of the bottom of the handheld virtual shoe being evaluated by the disclosed system.

FIG. 4c is an illustration of an arbitrary angle of the left side view of the handheld virtual shoe being evaluated by the disclosed system.

FIG. 4d is an illustration of an arbitrary angle of the top right side view of the handheld virtual shoe being evaluated by the disclosed system.

FIG. 5 is an additional optional component of the system illustrated in FIG. 3.

FIG. 6 is a flowchart illustrating an example process for an embodiment evaluating virtual produce items for online grocery purchase.

FIG. 7a is an arbitrary angled view of one part of an avocado using an embodiment including a produce evaluation system.

FIG. 7b is an arbitrary angle view of a bottom of an avocado using the embodiment including a produce evaluation system.

FIG. 7c is an arbitrary angle view of a back of an avocado using the embodiment including a produce evaluation system.

FIG. 7d is an arbitrary angle of a top view of an avocado using the embodiment including a produce evaluation system.

FIG. 8a is an image of a virtual product in a first configuration as seen on a mobile computing device.

FIG. 8b is image of the virtual product in a second configuration, following user interaction, as seen on a mobile computing device.

Throughout this description, elements appearing in figures are assigned three-digit reference designators, where the most significant digit is the figure number and the two least significant digits are specific to the element. An element that is not described in conjunction with a figure may be presumed to have the same characteristics and function as a previously-described element having a reference designator with the same least significant digits.

### DETAILED DESCRIPTION

To decide whether to buy an item in a physical store, a shopper would pick up the item, look at the item from all angles, and maybe hold it closer to his face to view smaller details. The online sales industry needs the virtual equivalent of being able to hold a product and look at it from all sides. There is also a need to view virtual products in real scale. Physically holding a product allows the user to decide if the size of the product fits the user's purpose. The shopper should be able to view the actual size of a handheld product as if the shopper was holding it in his hand to get a true and clear idea of the size of the product. An embodiment of this system and method could also be implemented as part of an online shopping application to evaluate specific pieces of produce for approved purchase. The shopper would be able to determine if the color of the produce indicated the amount of desired ripeness or if there were too many bruises on the produce.

The current system provides a shopper with a similar natural interaction in the virtual world of online sales that he would receive holding an item in his hand in a physical store. A physical three-dimensional object acts as both a trackable object for insertion of an augmented three-dimensional image of a product (a virtual product) the user is interested in as well as a tangible object to naturally manipulate as the user would if he were holding the product itself. The tangible object can be a triangular prism, a pyramid, a rectangular prism, a cube, or any other three-dimensional shape. For brevity and to avoid confusion between the trackable physical object and the virtual object, throughout the remainder of the description the term “cube” is used often in place of the trackable three-dimensional physical object. A cube provides many benefits in a preferred embodiment of the system, but any three-dimensional object can be used in place of a cube; the system is not limited by the term cube, and use of “cube” throughout the disclosure should not be read to incorporate any limitations to the disclosed system or method

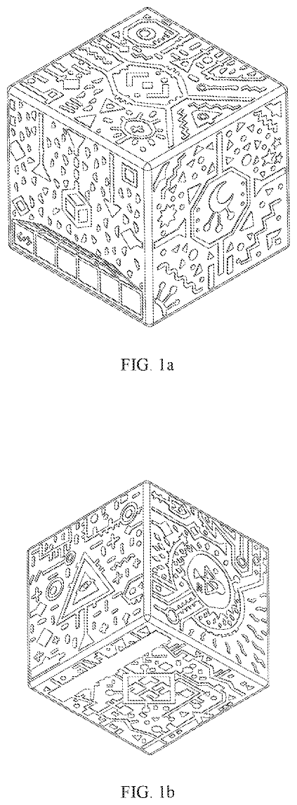

FIG. 1a and 1b show an example of components for the disclosed system.

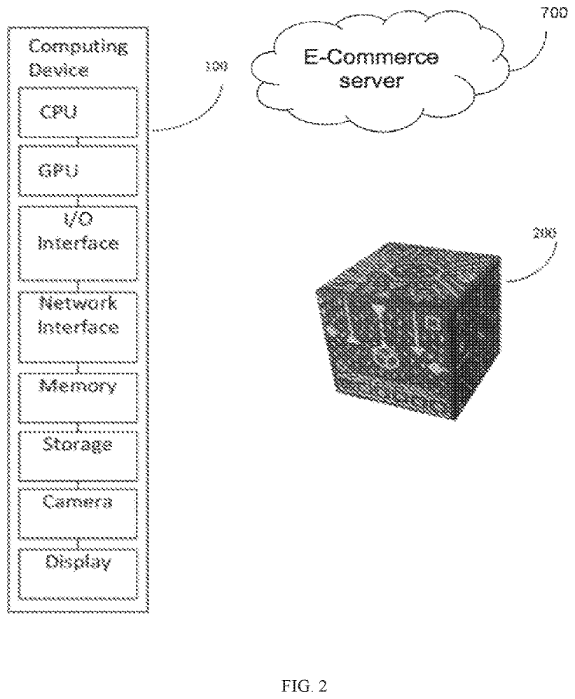

Turning to FIG. 2, this embodiment includes a computing device 100 and a three-dimensional object 200 that is trackable and an e-commerce server 700 that provides the virtual object to the shopper to evaluate. This ability to be tracked can be implemented in a number of ways known in the art. One of the simplest and least expensive ways to make the three-dimensional object trackable is through the use of unique markers on each of the sides of the three-dimensional object. A processor of a computing device 100 can be programmed to use a connected camera to track the motion and position of the unique fiducial markers on the object (as the arrangement of the markers on each face of the object in relation to the others is known) and can insert a virtual object for the user to view on a display connected to the computing device.

A mobile computing device 100 such as a smartphone usually includes all of the hardware required of a computing device for the disclosed system, though the system is not limited to a smartphone, in fact the various systems attributed to the computing device do not have to be housed in the same housing and instead could be various components in communications with each other. The parts of the system should include the trackable three-dimensional physical object 200 and a computing device 100 with a processor and in communication with a camera, a display, memory, and ability to communicate with a network.

Processor(s) may be implemented using a combination of hardware, firmware, and software. Processor(s) may represent one or more circuits configurable to perform at least a portion of a computing procedure or process related to 3D reconstruction, Simultaneous Localization And Mapping (SLAM) or similar functionality, tracking, modeling, image processing, animation etc. and may retrieve instructions and/or data from memory.

The memory may include a combination of volatile and/or non-volatile memory including read-only memory (ROM), static, dynamic, and/or magnetoresistive random access memory, and nonvolatile writable memory such as flash memory. The memory may store software programs and routines for execution by the CPU or GPU (or both together). These stored software programs may include operating system software. The operating system may include functions to support the I/O interface or the network interface, such as protocol stacks, coding/decoding, compression/decompression, and encryption/decryption. The stored software programs may include an application or “app” to cause the computing device to perform portions or all of the processes and functions described herein. The words “memory” and “storage”, as used herein, explicitly exclude transitory media including propagating waveforms and transitory signals.

Storage may be or may include non-volatile memory such as hard disk drives, flash memory devices designed for long-term storage, writable media, and other proprietary storage media, such as media designed for long-term storage of image data.

The camera is an electronic device capable of capturing an image of those objects within its view. The camera is shown as a single camera, but may be a dual-lens or multi-lens camera. Likewise, the word camera is used generally, but the camera may include infrared lighting, a flash or other pointed light source, an infrared camera, depth sensors, light sensors, or other camera-like devices capable of capturing images or detecting three-dimensional objects within range of the camera. Though camera is described as a visual imaging camera, it may include additional or other capabilities suitable for enabling tracking. For example, lasers and/or sound may be used to perform object tracking using technologies like LIDAR and Sonar. Though neither technology involves a “camera” per se, both may be used to augment or to wholly perform object tracking in three-dimensional space.

The display is an electronic device that incorporates electrically-activated components that operate to form images visible on the display. The display may include backlighting (e.g. an LCD) or may be natively lit (e.g. OLED). The display is shown as a single display but may actually be one or more displays. Other displays, such as augmented reality light-field displays (that project lights into three-dimensional space or appear to do so, or other types of projectors (actual and virtual), may be used. Retinal projection may also be used, in which case, a display may not be required.

The display may be accompanied by lenses for focusing eyes upon the display and maybe presented as a split-screen display to the eyes of a viewer, particularly in cases in which the computing device is a part of an AR/VR headset. The AR/VR headset is an optional component that may house, enclose, connect to, or otherwise be associated with the computing device. The AR/VR headset may, itself, be a computing device, connected to a more-powerful computing device, or the AR/VR headset may be a stand-alone device that performs all of the functions discussed herein, acting as a computing device itself. Some embodiments of the system include an AR/VR headset or Head Mounted Display (HMD) that enhances the user's experience. Incorporating an HMD into the system allows the user to use both hands to manipulate the three-dimensional physical object, to ensure viewing of all sides of the virtual product. HMDs can be especially helpful in embodiments of the system where specific predefined movements of the cube itself act as a user interface controlling the content being shown on the display.

One particularly useful computing device 100 that can be utilized with this system is a mobile computing device, which refers to a portable unit with an internal processor/memory, rear-facing camera, and a display screen, such as a smartphone. Mobile computing devices can be smartphones, cellular telephones, tablet computers, netbooks, notebooks, personal data assistants (PDAs), handheld video game devices, multimedia Internet enabled cellular telephones, and similar personal electronic devices that include a programmable processor/memory, camera, and display screen. Such mobile computing devices are typically configured to communicate with a mobile bandwidth provider or wireless communication network and have a web browser.

The exemplary mobile computing device includes a central processing unit (CPU), a screen, a back facing camera, and wireless communication functionality, and may be capable of running applications for use with the system. In some embodiments, an audio port may be included, whereby audio signals may be communicated with the system. The mobile computing device may incorporate one or more gyroscopes, gravitometers, magnetometers, accelerometers, and similar sensors that may be relied upon, at least in part, in determining the orientation and movement of the overall system. In some embodiments, the mobile computing device may be a third-party component that is required for use of the system, but is not provided by or with the system. This keeps cost down for the system by leveraging the user's current technology (e.g., the user's mobile computing device).

The camera on the mobile computing device recognizes the markers and their orientation on the cube; a virtual product chosen by the user to evaluate is inserted in the display aligned with the orientation of the cube. As the camera of the mobile computing device tracks the orientation and motion of the cube, the correlating rotation and motion is shown in the virtual product through the display of the mobile computing device. Using this system, the user can examine the chosen product from all angles and views. He can turn the cube in any direction. As the cube rotates in a natural way through all axes, so does the three-dimensional virtual product.

A cube 200 has several characteristics that make it uniquely suitable for tracking purposes. Notably, only six sides are present, but each of the six sides may be unique and relatively differentiable from one another. The differentiation can be accomplished in many different and trackable ways (even if another shape is used in place of the cube, similar tracking methods can be used). For example, a cube 200 may have different colors on each side; only six colors are required for differentiation based upon color-use or lighting-use of particular colors. This enables computer vision algorithms to easily detect which side(s) are facing the camera, and because the layout of colors is known, and certain colors are designated as up, down, left, right, front, and back, the orientation of the cube 200 can be matched one-to-one with a virtual object and easily tracked. The computer vision can predict which side is being presented based on the movement of the cube in any direction with the known layout of markers.

Similarly, computer-readable (or merely discernable) patterns may be applied to each side of a cube 200 without having to account for more than a total of six faces. If the number of faces is increased, the complexity of detection of a particular side—and differentiating it from other sides or non-sides—increases as well. Also, if keeping the three dimensional physical object 200 handheld in size, the total surface area for a “side” decreases as more sides are added, making computer vision side-detection algorithms more difficult, especially at different distances from the camera, because only so many unique patterns or colors may be included on smaller sides. Further, the smaller the side, the higher the likelihood for occlusion by the user's hand which increases the potential for losing tracking of the trackable object. The trackable three-dimensional physical object (“trackable object” or “cube”) of the disclosed system and method is highly intuitive as an interface and removes a technology barrier that can exist in more standard software-based user interfaces.

100431 Similarly, if fewer sides are used (e.g. a triangular pyramid), then it is possible for only a single side to be visible to computer vision at a time and, as the pyramid is rotated in any direction, the computer cannot easily predict which side is in the process of being presented to the camera. Therefore, it cannot detect rotational direction as easily. More of each “side” is obscured by individuals holding the trackable three-dimensional object because it simply has fewer sides to hold. This makes computer vision detection more difficult.

FIGS. 1a, FIG. 1b and FIG. 2 show embodiments of a three-dimensional physical object bearing unique markers to achieve accurate tracking with the disclosed product evaluation system. Generally, in embodiments using markers for computer vision tracking, the markers used on the various faces of the cube (or other trackable three-dimensional physical object) can be many different designs, colors, patterns, and formats. They can be any black and white designs or patterns. The patterns can include large and small parts to increase accuracy of tracking, with the patterns on each side of the object being unique. Markers can simply be solid colors recognizable by computer vision, with each side having a different color, and the arrangement of the colors being known. Unique QR codes can be created for each side with a known arrangement. The trackable object may bear markers that allow for at least two detection distances and are capable of detection by relatively low-resolution cameras in multiple, common lighting situations (e.g. dark, light) at virtually any angle.

The technique of including at least two (or more) sizes of markers for use at different detection depths, overlaid one upon another in the same marker, is referred to herein as a multi-layered marker.” The use of multiple multi-layered markers makes interaction with the cube (and other objects incorporating similar multi-layered markers) in augmented reality environments robust to occlusion (e.g. by a holder's hand or fingers) and rapid movement, and provides strong tracking through complex interactions with the cube 200. In particular, high-quality rotational and positional tracking at multiple depths (e.g. extremely close to a viewing device and at arm's length or across a room on a table) is possible through the use of multi-layered markers. FIG. 1a and FIG. 1b show example faces of the six sides of the cube that utilize these multi-layered markers. Other electrical methods of tracking using lights or sensor(s) is also possible, though using markers as discussed above is a less complex and less expensive implementation of the invention.

All of the foregoing enables finely-grained positional, orientation, and rotational tracking of the cube 200 when viewed by computer vision techniques at multiple distances from a viewing camera. When held close, the object's specific position and orientation may be ascertained by computer vision techniques in many lighting situations, with various backgrounds, and through movement and rotation. When held at intermediate distances, due to the multi-layered nature of the markers used in this embodiment, the object may still be tracked in position, orientation, through rotations and other movements. With the high level of tracking available, the cube 200 may be replaced in the display with virtual products a shopper is interested in purchasing. Even minute motions of the cube can be tracked and shown in the virtual object on the display. Interactions with the cube 200 may be translated in the augmented reality environment (e.g. shown on an AR headset or mobile device, or shown on a display of a mobile computing device 100) and, specifically, to the virtual object on the display for which the cube 200 is a real-world stand-in.

The virtual product may also be viewed to scale through the display. The exact dimensions of the cube the user holds are known. The exact dimensions of any product that the user might choose to evaluate are also known. The scale of the virtual product as presented in the display can be made to correspond to those known dimensions of the physical product. Many areas of online sales could benefit from such a actual scale virtual viewing system.

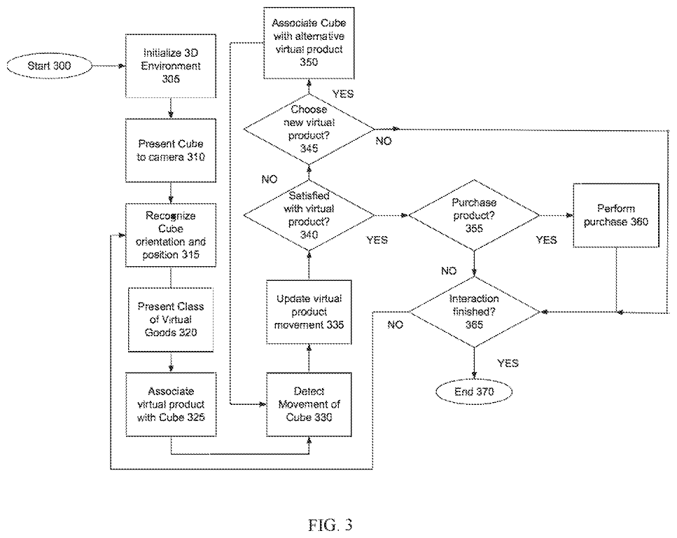

In an embodiment of the current system, the process of evaluating virtual products for purchase is illustrated in FIG. 3. The flow chart has both a start 300 and an end 370, but the process is cyclical in nature. The process may take place many times while a computing device is viewing and tracking a cube or other trackable three-dimensional object, and the shopper may evaluate and purchase multiple virtual objects for purchase. The process starts at 300, then continues to 305 to initialize the environment. In one embodiment, a camera in communication with a computing device (e.g., a smartphone) along with associated software maps the user's environment in an initialization process. The user's environment is shown through the camera feed on the display associated with the computing device.

The next step 310 is to present the cube (or other trackable three-dimensional object) to the camera in communication with the computing device. In the most common case, this camera will be the camera on a mobile device (e.g. an iPhone@) that is being used as a “window” through which to experience the augmented reality environment. The camera does not require specialized hardware and is merely a device that most individuals already have in their possession on their smartphones. In this and other examples, computing device, mobile computing device, and smartphone are used interchangeably. These are merely examples; no limitations of any of the group should be imposed on the disclosure as a whole.

Next, the cube is recognized by the camera of the computing device at 315 while the position, orientation, and motion begin being tracked. At this stage, not only is the cube recognized as something to be tracked, but the particular side, face, or marker (and its orientation, up or down, left or right, front or back, and any degree of rotation) is recognized by the computing device. The orientation is important because the associated software also knows, if a user rotates the object in one direction, which face will be presented to the camera of the computing device next and can cause the associated virtual object to move accordingly. At 315, position, orientation and motion (including rotation) begin being tracked by the computer vision software in conjunction with the camera.

Next at 320, a class of virtual goods may be presented to the shopper. This could be presented in any number of ways. For example, if a shopper is using the system to evaluate jewelry for purchase, each of the sides of the cube could display a different category of jewelry (e.g., rings, earrings, necklaces, bracelets, etc.). The user could select which category to expand.

Once in the watches category, for example, the shopper could then choose a specific watch to associate with the cube at step 325. This selection can be made through some user interface selection on the display or even through a specific, predefined motion of the cube, or any other way known in the art to interface with a computing device. Once the cube is associated with a virtual object, the virtual object is shown on the display at the same position and orientation of the cube. The cube may be a stand-in for an industrial part, a piece of art, or any other product for sale, including the watch in the current example. The scale of the virtual object could be the real-life size of the object if it is hand-held, a scaled down version if the object is large (e.g., an airplane), or a scaled-up version of the object if it is small or microscopic (e.g., an earring).

Once the three-dimensional object is associated with a particular virtual object at 325, movement of the cube may be detected at 330. Movement can be translational “away from” a user (or the display or camera) or toward the user, in a rotation about an axis, in a rotation about multiple axes, to either side or up or down. The movement may be quick or may be slow. The tracked movement of the cube is updated in the associated virtual object at step 335. This update in movement of the virtual object to correspond to movement of the cube may happen in real-time, with no observable delay. The movement is not restricted to incremental degrees or stepped, predetermined points; rather the motion of the virtual object is the natural motion of the cube in the user's hand and can be manipulated in the same way, as if holding the virtual object.

During this part of the process at step 340, it is determined whether the shopper is satisfied with the virtual product. The shopper can determine if the size of the watch is appropriate for his wrist as the virtual watch is exactly the same size as the actual watch would be due to the known size of the cube. He can hold it closer to the camera as he would hold the watch closer to his eyes in real life to see the fine detail on the face. If the user is satisfied with the product (“yes” at 340), he can decide whether to purchase it at decision step 355. If he chooses “no” at 340, the user can select a new virtual product to evaluate at 345. If the shopper chooses to view a new product at 345, a new alternative virtual product is associated with the cube at step 350. The process cycles back to step 330, detecting movement or the cube and updating the virtual object. This cycle of offering alternative virtual objects for evaluation continues until the shopper either is satisfied with the virtual product at 340, or chooses not to choose a new virtual product at 345.

If the shopper is satisfied with the virtual object at 340, and chooses to purchase the product at 355, the purchase is performed at 360. The performance of purchase could be adding the product to a cart and then checking out (at the same time or at some later time, in which case the contents of the cart might be saved for later use) in an online purchasing system. There may or may not be a cart, the user may directly purchase the product without the use of the cart. Once the purchase is completed at 360 or the shopper chooses not to purchase the product (“no” at 355), the process continues to decision step 365 where the shopper decides whether the interaction is finished. This could be indicated with an affirmative selection to be finished by the shopper, closing of the software or application, or a timed shutdown feature, or any other method known in the art. If the shopper is not finished with the interaction, the process circles back to recognizing the cube at 315, and then continues as discussed above.

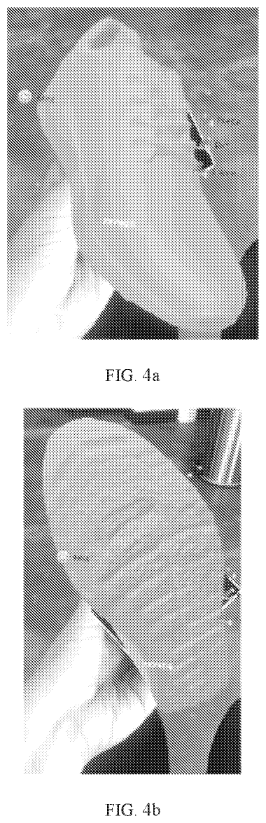

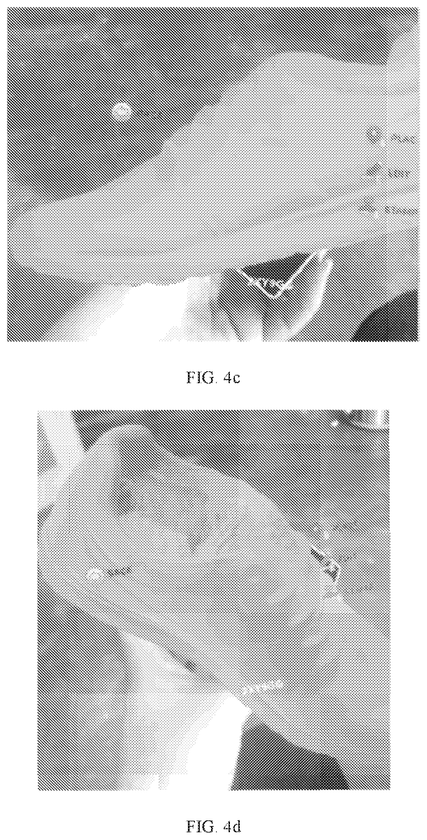

FIGS. 4a-4d show an example of an embodiment of this disclosed system, a shopper who wants to evaluate a new shoe can see the three-dimensional virtual image of the shoe in his hand (in a chosen size) exactly how it would look in the physical world. The shopper can turn the shoe around (by turning the cube) to view the location of the rear-facing camera. He can turn the shoe upside down and sideways by turning the cube in the same way allowing him to see all sides (FIG. 4a, 4c) including the tread on the bottom of the shoe as in FIG. 4b and the inside coloring of the shoe in FIG. 4d. Importantly, the views are not limited to top, bottom, front, rear, left and right. The cube can be turned naturally in the user's hand in any number of degrees in any direction; the three-dimensional virtual product is also able to be manipulated naturally in the user's hand, as the movements of the cube control corresponding movement in the virtual product.

A shopper in the market for a new shoe could hold it in her hand and examine it naturally from all angles by manipulating the cube just as she would the shoe. She could see the sole FIG. 4b and the interior of the shoe FIG. 4d. She could hold the shoe closer to her face to examine the stitching. She could see exactly how tall the heel of the shoe was; she would see the shoe through the display as it would look if she physically held it in her hand. (FIGS. 4a-4d). If she was curious about what the shoe would look like from a distance, she could simply set the cube on the floor or any surface, and view the shoe through the display of the mobile computing device to see what it would look like to scale from a distance.

The user could see an exploded view of the shoe that highlights its various features. In some embodiments, the user could view a video of how the shoe would move with a wearer's foot during walking or running. Various features of the shoe or other available options could be viewed. For example, the user can view other color options or other models of a virtual product. If the user likes the size of the product after viewing the virtual object through the display, but is unhappy with the color, the user could select to view the virtual product in other available colors. The selection of the color to view could be made through a menu on the user interface of the display, a tilt of the display or other specific movements of the display could be interface inputs.

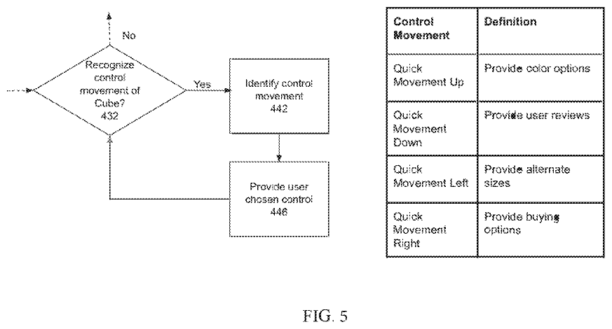

The user can find other information about the product including price, reviews, other available versions of the product, or even other buying options. In some embodiments of the disclosure, the tracked movement of the cube can be used as an interface input. FIG. 5 illustrates an example of this type of embodiment as an extension to FIG. 3 above. At any point in the process once the cube is being tracked, specific movements of the cube can be recognized to have correlated intended inputs at step 432. The recognized movement is then identified by the system at 442. For example, during the evaluation process of the shoe, a shopper might provide a quick movement vertically, which the system may recognize as a desire for a list of other colors in which the shoe is available for purchase (in accordance with step 446). Once that menu of colors is shown, the user could rotate the cube to select a desired color. At that point, the process would revert to whatever step the shopper was on in the original process.

The system could utilize a table of predefined movements such as the one in FIG. 5. The table provides some example definitions for specific movements. For example, quick movement up vertically could correspond to a request to provide alternate color options. Quick movement down vertically could correspond to a request for user reviews of the product being evaluated. Quick movement of the cube to the left could correspond to a request to provide alternate sizes available to the shopper. Quick movement to the right may correspond to a request for available buying options for the shopper. The table of FIG. 5 is only an example of the types of movements of the cube that could correspond to requests for more information by the user. There could be more movements or different movements that correspond to more requests by the user, or different request by the user.

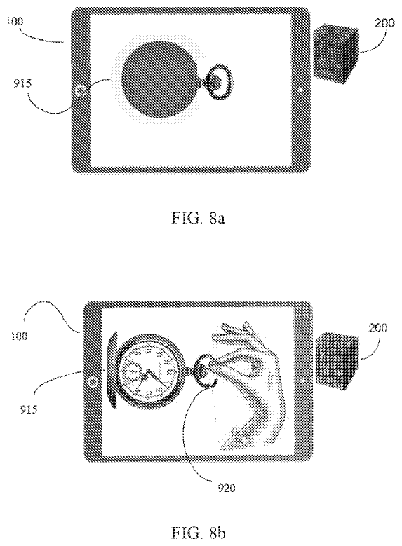

Other methods might be used to request more information that can be input in other ways. On a smartphone, the user interface of a touchscreen might include a menu or icons to press to make these requests. Some embodiments take advantage of hand or finger tracking technology. FIG. 8a and FIG. 8b show an embodiment using such hand/finger tracking in the disclosed system. If a potential buyer wanted to examine a pocket watch for purchase, he could load its virtual counterpart using the system like in FIG. 8a. Once associated with the cube 200, the buyer could view the pocket watch 910 from all angles. To see the inside, the system could track the finger 915 of his other hand not holding the cube 200; when the fingers 915 “turn” the clasp on the virtual pocket watch 910, it would open to show the watch face as shown in FIG. 8b The pocket watch 910 could even be animated such that the second hand would be moving. If they system was using sound, the second hand could be heard ticking. The system may track the buyer's finger to “shut' the cover of the pocket watch 910 as well. This finger tracking functionality could be useful for other handheld products that have buttons, switches, opening/closing portions, or other options in which a potential buyer might be interested.

One other method of input may include gaze detection and tracking if the system includes a front facing camera as well as a rear facing camera. Gazing on a particular input icon for a preset number of seconds could actuate an input in the user interface. Gaze tracking could also be utilized in the system where a gaze on any portion of the virtual product for a preset number of seconds could create a pop-up box with more information on that portion or feature. Gaze detection could be used to “press” a button on the virtual object to see it working, or to create a touch input in the user interface in a system utilizing a touch screen. Any other method on providing user input known in the art might be used; the disclosed system and method are not limited to inputs only made through movement of the cube.

In another example, if a shopper is deciding whether or not to purchase a purse, she could hold the purse in her hand. Because the dimensions of the cube are known, and the dimensions of any selected product are known, the virtual purse displayed on the screen appears in its real physical size as it would be held in the user's hand. The user can rotate the purse on all axes in a natural way just as the user would if examining a purse in the physical world. Further the user might interact with the cube to correspond to the opening of the virtual purse to examine its interior in some embodiments. In examples of other virtual objects that includes lights or sounds, the virtual object can be animated to show those options functioning as they would in real life. The tangible cube along with a robust user interface allows the buyer to examine and observe richer functionality in the virtual product, including simulations and interactions with the virtual product which can be better viewed in 3D.

If a virtual item is too big to hold in the user's hand, this system also has a feature to view even a bigger item in its actual size. The user can place the cube on a surface and see the chosen virtual item shown to scale through the display of the mobile computing device. The position and movement tracking functionality would continue to show the user all sides of the virtual product. The user could tilt the cube as one would a larger item in a physical store to see all sides or the top or bottom of the virtual product in its actual size.

Any number and type of products could be examined in this way, including but not limited to mobile phones, purses, jewelry, shoes, plates, glasses, flatware, cameras, tablets, fishing lures, screws, nails, tools, pet toys, craft supplies, hair appliances, produce, and other food items.

In the grocery industry, this system and method would be desirable, particularly with the recent explosion of online ordering of groceries. Often a buyer will receive ordered groceries with undesirable produce, maybe the bananas are green, or the avocados are too soft for the buyer's purposes. The disclosed system and method solve this problem. A buyer can order groceries online as usual. When the personal shopper is choosing the produce, a 3D image of the item, can be scanned and uploaded to a server that the buyer can access to immediately review and approve or reject the item. Alternative items can be presented for approval or rejection until the requisite number of approved items have been collected by the personal shopper.

In another embodiment, once the buyer has approved one of a variety of produce, the personal shopper will continue to choose other items of similar apparent ripeness or color. This system would be even faster using this embodiment. The ability to view the three-dimensional model of the actual apple a person is potentially buying on all sides and interacting with it as if holding it in your hand is a natural intuitive way to choose which apple to buy. This system could be implemented in any number of ways. In some embodiments there could be representative ranges of ripeness of apples that are pre-scanned, and the personal shopper would choose produce to match the user chosen range of ripeness for all of the requested apples in the order.

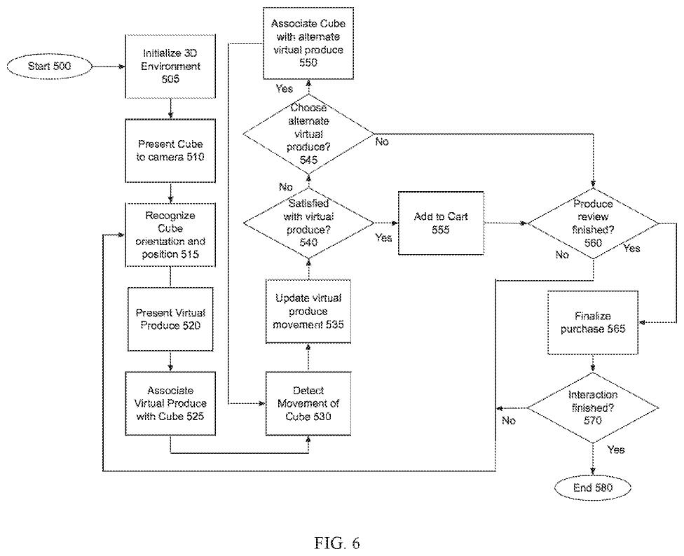

FIG. 6 is a flowchart of an example process for one embodiment for purchasing produce where the buyer sees a three-dimensional model of the exact piece of produce the personal shopper is going to buy. The process is similar to the earlier discussed process in FIG. 3 with similar possible implementations. It is also similarly cyclical and can be performed continuously until the buyer is satisfied with all of the produce selections. The process starts at 500 and continues to initialize the three-dimensional environment at 505. In this process, the virtual object is the particularly requested produce item. The produce can be viewed from all angles for bruised spots, evenness of color, or any imperfections. The process progresses like in FIG. 3 until 540 (the similarly numbered 340 in FIG. 3) to the decision whether the viewer is satisfied with the virtual produce. If yes is chosen, and the viewer wants to purchase the item, it is added to a cart at 555. Being added to the cart is just one example of a way to indicate that the user wishes to purchase the apple; other methods could be implemented including swiping in a user interface in a certain direction (left, right, up, down); like discussed above, predefined movements of the cube can be inputs to determine whether or not the user is satisfied with the particular produce item being evaluated.

Once the approved produce is added to the cart or otherwise approved at 555, the process progresses to decision step 560 to determine if produce approval is finished. If the review process is not finished (“no” at 560), the process cycles back to recognizing the cube orientation and position at 515, then to present another item of virtual produce at 520 and so on until it is determined at 560 that produce review is finished. Once “yes” is achieved at 560, the process continues to purchase finalization at 565. Finalizing the purchase can be achieved by any method known in the art using a platform included in the grocery review system; it can also send the buyer to a third-party system to complete the purchase process. The user can make these selections on a touchscreen of a smartphone if using one as part of the system, use some other method know to create input for a computer, or use the cube itself to perform predefined motion to achieve an input. At decision step 570, it is decided whether the interaction is finished. At this step, the software may simply be closed, or the mobile device or other computing device be put away. If so (“yes” at 570), then the process is complete at end point 580. If not, (“no” at 570), then the three-dimensional object may have been lost through being obscured to the camera, may have moved out of the field of view or may otherwise have been made unavailable. The process may continue with recognition of the object and its position at 515 and the process may continue from there.

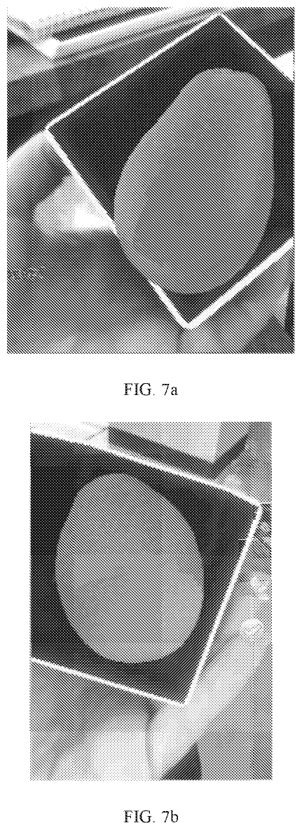

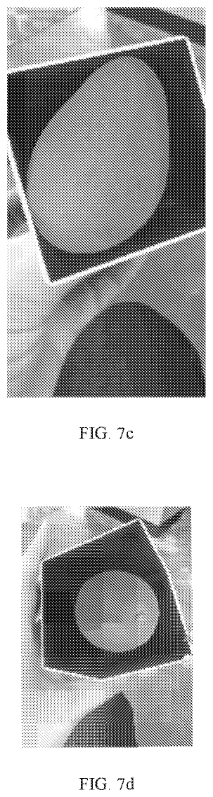

Using this process a buyer can see, examine and approve the actual avocado that the personal shopper purchases for him. FIGS. 7a-7d show a user examining an avocado from all sides by manipulating the cube as a placeholder for the avocado. FIG. 7a shows one side of the avocado to scale, FIGS. 7b, 7c, and 7d show other views of the avocado. It is important to note that these images only capture that moment in time, and the buyer can look at the virtual avocado from any angle, and rotate it about any axis to evaluate all parts of it. Using the trackable three-dimensional physical object as a placeholder for the virtual product, the user can “turn” the avocado all around to examine the color for desired ripeness, checking for brown spots. FIG. 7c shows some small brown spots on the avocado. The user would be able to see those spots as if holding the avocado in his hand. Further the avocado is shown on the display at the size it would be were the buyer holding it in the physical environment. The buyer can determine if it is the appropriate size/ripeness for her purposes. If not, the buyer can elect to alert the personal shopper to any objections she might have, or provide specific directions to inspect a difference avocado for purchase. These directions could be something like: “I would like a smaller one” would like a larger one”; or “I would like a less ripe one”. Multiple other instructions could be sent in real time to the personal shopper to ensure that the produce purchased is what the buyer wants. The method and content of these alerts can be in many different forms in the disclosed system and method. To create a user input, the user could select an icon on the user interface; use predefined movements of the cube; swipe on a touchscreen if using a mobile device; tilt the display; actuate a tracked hand or gaze gesture. The system could include a messaging option as a component or direct the user to a third-party messaging system to send text messages to the complete the messaging feature. Text messages could be used in either instance if particular directions are required. Generally providing the user with a set of easily selectable common directions such as those listed in the example above is a faster and easier option.

### CLOSING COMMENTS

Throughout this description, the embodiments and examples shown should be considered as exemplars, rather than limitations on the apparatus and procedures disclosed or claimed. Although many of the examples presented herein involve specific combinations of method acts or system elements, it should be understood that those acts and those elements may be combined in other ways to accomplish the same objectives. With regard to flowcharts, additional and fewer steps may be taken, and the steps as shown may be combined or further refined to achieve the methods described herein. Acts, elements and features discussed only in connection with one embodiment are not intended to be excluded from a similar role in other embodiments.

As used herein, “plurality” means two or more. As used herein, a “set” of items may include one or more of such items. As used herein, whether in the written description or the claims, the terms “comprising”, “including”, “carrying”, “having”, “containing”, “involving”, and the like are to be understood to be open-ended, i.e., to mean including but not limited to. Only the transitional phrases “consisting of” and “consisting essentially of”, respectively, are closed or semi-closed transitional phrases with respect to claims. Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements. As used herein, “and/or” means that the listed items are alternatives, but the alternatives also include any combination of the listed items.

It is claimed:

1. A system for viewing and inspecting virtual products for purchase comprising a trackable three-dimensional physical object and a computing device including a memory, and a processor in communication with a display and a camera, the processor executing instructions which cause the processor to:
detect and track the trackable three-dimensional physical object; and
display a visible image representing the trackable three-dimensional physical object on the display of the computing device, where a three-dimensional virtual model of a product to be inspected is shown in place of the trackable three-dimensional physical object, wherein movement and rotation of the trackable three-dimensional physical object is reflected as a corresponding movement and rotation in the three-dimensional virtual model of the product on the display.

2. The system of claim 1 wherein the instructions further cause the processor to:
enable user selection of multiple virtual products visible on the display; and
update the display to show a selected one of the multiple virtual products as the three-dimensional virtual model of the product in response to the user selection.

3. The system of claim 1, wherein the instructions further cause the processor to enable a purchasing option of an inspected virtual product based upon a user selection.

4. The system of claim 1 wherein the purchasing option directs a user to a third-party platform to purchase the inspected virtual product.

5. The system of claim 1 wherein the purchasing option completes the purchase without further interaction from the user.

6. The system of claim 1, wherein the trackable three-dimensional object is a cube bearing unique fiducial markers on at least two of its sides.

7. The system of claim 1, wherein the instructions further cause the processor to update the display to show additional information regarding the product upon user interaction requesting additional information.

8. The system of claim 7, wherein the additional information includes at least one of customer reviews, customer ratings, buying options, available colors, and available sizes.

9. The system of claim 1, wherein user interactions with the product are based upon at least one of the group of: swiping gestures on a touchscreen of the display, touching a specific area of a touchscreen of the display, tilting the display, recognizing predefined motion of the trackable three-dimensional physical object, hand tracking, and gaze tracking.

10. A method for viewing and inspecting virtual products for purchase comprising:
detecting and tracking a trackable three-dimensional physical object; and
displaying a visible image representing the trackable three-dimensional physical object on a display of a computing device, where a three-dimensional virtual model of a product to be inspected is shown in place of the trackable three-dimensional physical object, wherein movement and rotation of the trackable three-dimensional physical object is reflected as a corresponding movement and rotation in the three-dimensional virtual model of the product on the display.

11. The method of claim 10 further comprising:
enabling user selection of multiple virtual products visible on the display; and
updating the display to show a selected one of the multiple virtual products as the three-dimensional virtual model of the product in response to the user selection.

12. The method of claim 10 further comprising enabling a purchasing option of an inspected virtual product based upon a user selection.

13. The method of claim 10, wherein the purchasing option directs a user to a third-party platform to purchase the inspected virtual product.

14. The method of claim 10, wherein the purchasing option completes the purchase without further interaction from the user.

15. The method of claim 10, wherein the trackable three-dimensional object is a cube bearing unique fiducial markers on at least two of its sides.

16. The method of claim 10, further comprising updating the display to show additional information regarding the product upon user interaction requesting additional information.

17. The method of claim 16, wherein the additional information includes at least one of customer reviews, customer ratings, buying options, available colors, and available sizes.

18. The method of claim 10, wherein user interactions with the product are based upon at least one of the group of: swiping gestures on a touchscreen of the display, touching a specific area of a touchscreen of the display, tilting the display, recognizing predefined motion of the trackable three-dimensional physical object, hand tracking, and gaze tracking.
